(19) United States
(12) Patent Application Publication
(10) Pub. No.: US 2007/0181069 A1
(43) Pub. Date: Aug. 9, 2007

(54) Automatic livestock feeder

(76) Inventor: Douglas Lowell Jack, Plimce George (CA)

Correspondence Address: Douglas Lowell Jack, 14820 Miworth Rd., Plimce George, BC, V2M 7C3, US

(21) Appl. No.: 11/699,060

(22) Filed: Jan. 29, 2007

Related U.S. Application Data
(60) Provisional application No. 60/766,667, filed on Feb. 3, 2006.

(51) Int. Cl. A01K 5/01

(52) U.S. Cl. 119/61.1

(57) ABSTRACT

This invention is for the purpose of feeding hay to livestock in a controlled and timed manner. It's comprised of a base, four sides, roof, and floor and is able to contain one large round bale, or the equivalent in loose hay or square bales. Three gate assemblies are used, consisting of a double gate in which an outer feed gate moves up and down and a fixed inner gate remains stationary. Operation of the feed gates is controlled by a programmable timer, which in conjunction with a 12 VDC air system, raises and lowers the feed gates. Power is provided by either 110 VAC or a completely self-contained 12 VDC system utilizing solar panels. The loading of feed into this invention is accomplished by opening one of the gate assemblies, which are hinged on one side, to allow the whole gate assembly to swing open to facilitate loading and cleaning.

This application claims benefit of prior application No. 60/766667 which was filed on Feb. 3, 2006. Jan. 17, 2007

The present invention relates to an automatic livestock feeder. The invention can be categorized as a unique approach to the problem of feeding loose or baled hay to livestock in a quantity controlled and waste efficient manner and is a self-contained, timer controlled and automated, fully enclosed hay feeding device.

### BACKGROUND OF THE INVENTION

Ever since the introduction of widespread hay bale production the re-occurring problem with hay feeding, especially in small hobby or commercial operations, has been the inability to control how much feed is being consumed and how much is being wasted. Generally, most livestock will consume more feed than they require. Unconsumed and loose feed being trod on by livestock or spoilt by the elements wastes an additional and significant portion. In view of these problems various approaches to a solution have been taken. These devices generally fall into two categories:

1. Processed feed disbursement (e.g. feed pellets and grain)

2. Loose hay and baled hay feeders

The latter of which is usually a basic containment area with no floor to reduce wastage and no roof structure to preserve the feed. In addition, they generally have no or limited automation of the feeding time duration or frequency in order to control the amount of feed consumed, and do not incorporate any form of automated “default to feed mode” in case of system failure, (e.g. Sturgis U.S. Pat. No. 6,550,421). In general, these feeders are labor intensive in that they have to be opened up or flipped over in order to load feed into them and in so doing often get bent or damaged. Also, livestock, especially cattle will sometimes damage or dislodge “empty” feeders. In addition, many of these types of hay feeders incorporate some type of “neck bars” to prevent the animals from climbing into the feeder. This type of barrier tends to allow horses to rub the hair from their manes and some designs using these types of barriers have been known to be a source of injury to young horses.

Below are references to other previous inventions designed to dispense loose or baled hay feed to livestock.
CA 2399831 Dalman
CA 2115983 Dyson
CA 2236017 Bondarenko
CA 2113150 Rumbaugh
CA 1246403 Rapp
CA 1061663 Schoessow
U.S. Pat. No. 6,550,421 Sturgis

These types of feeders have generally worked well in previous years when feed related costs were relatively low, but with today's higher costs to the animal owners in time and money, there exists a continuing need for improvement.

### SUMMARY OF THE INVENTION

This new invention addresses the major obstacles faced by previous loose hay and baled hay feeders by incorporating the following unique features:
1. A square enclosure complete with a base, floor, a solid rear wall, a roof structure and three gate assemblies, into which hay, loose or baled, is contained, thus substantially reducing wastage during feeding. In addition, the gate assemblies are easily opened and closed, thus reducing time and labor that is required for loading feed into the unit.
2. Feeding is controlled by raising or lowering moveable feed gates, which is done by incorporating the use of compressed air, resulting in safe, gentle and dependable operation.
3. Feeding times are controlled by a 24-hour programmable timer system, thus controlling the amount of feed consumed during a preset feeding time-period.
4. A roof structure to protect the feed from the elements
5. A fully automated system that “defaults to feed mode” in the case of a feed gate control system malfunction, ensuring that the animals will feed and not be shut out.
6. The need for “neck bars” for use with horses is virtually eliminated, due to the inherent design of the invention. The use of these and other similar restraining devices is a major disadvantage of other previous designs, in that these devices rub out the horse's mane and is a constant problem. This feature is especially relevant in respect to “show horses”. In addition, the overall design of this feeder unit reduces the possibility of injury to young or rambunctious animals.
7. The problem of animals causing damage to or dislodging the unit is reduced, due to the inherent weight and structural integrity of the feeder unit.

In addition to the previously stated unique features of this invention, further descriptions of additional advantages of the embodiment are as follows:
1. The distance from the ground to the top of the feed gates in the feed position (gates down) can be varied, depending on the height of the animal, yet, still prevents the animal from entering the feeder by design. Furthermore, even if an animal did get inside the feeder, there are no sharp objects or obstacles with which to injure themselves. For feeding cattle only, neck bars can be added as an option—(not shown).
2. The unit is fully equipped to operate by either 110 VAC or 12 VDC. The 12 VDC system incorporates a battery and solar panels so as not to rely on 110 VAC if it is not accessible. Thus, the invention can be utilized as a fully self-contained feeding unit in remote settings. This invention utilizes 12 VDC to power the compressed air system, which through the use of uniquely designed air dryers, is free from wintertime moisture freezing problems.
3. The unit is fully covered by a roof structure to maintain dry feed and prevent spoilage by weather. In addition, the outer sheathing of steel mesh ensures that air can flow through the unit, facilitating the drying of damp feed.
4. The unit is mounted on skids, so as to be fully moveable in the pasture area. Additionally, there are lifting eyes and tow hooks to enable loading of the feed unit onto a vehicle for transport. Optional drift spikes are incorporated, that can be driven into the ground to ensure that the unit cannot be easily dislodged.
5. The load-sensing feature of the feed gates, inherent in the design of the invention, ensures that no harm comes to the animals, or people, during feed gate operation. This means that the up movement of the feed gates at the end of the preset feeding time is quite slow and can be stopped with light down pressure, (10-15 psi), (e.g. an animal leaning over the gate to feed), but when the animal raises its head slightly the feed gate will continue upward. The net result is that the animal is slowly yet firmly forced to back away from the feeder, thus ending the feeding period.
6. The three gate assemblies are hinged on one side to allow the complete gate assembly to be swung open without undoing any of the components, thus allowing for easy loading (e.g. a 6′ round bale using a tractor, or hand loading approximately 12 to 16 square bales) and cleaning. The opening and closing of the gates can be done with the feed gates up or down.
7. The time and labor saving features of this feeder unit are major advantages. This invention eliminates daily manual feeding and allows the animal caretakers to be away from the premises for extended periods of time. Plus, the invention reduces the amount of time and money spent in the moving of feed to the feeding area as well as the time and expense required cleaning up and disposing of compacted waste feed. Feeding efficiency is increased and wastage reduced, as well as allowing a more accurate monitoring of feed costs per animal.

### INDEX OF DRAWINGS

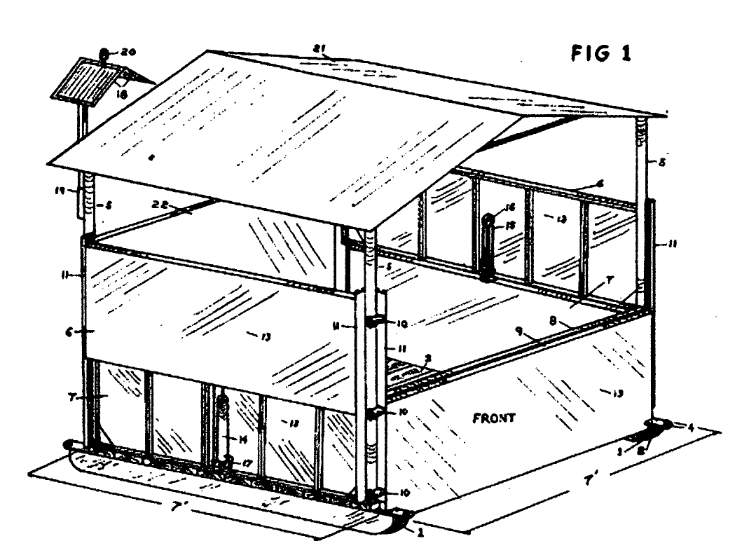

1. FIG. 1—an overall view of the invention showing one of the moveable outer feed gates down in the feeding position

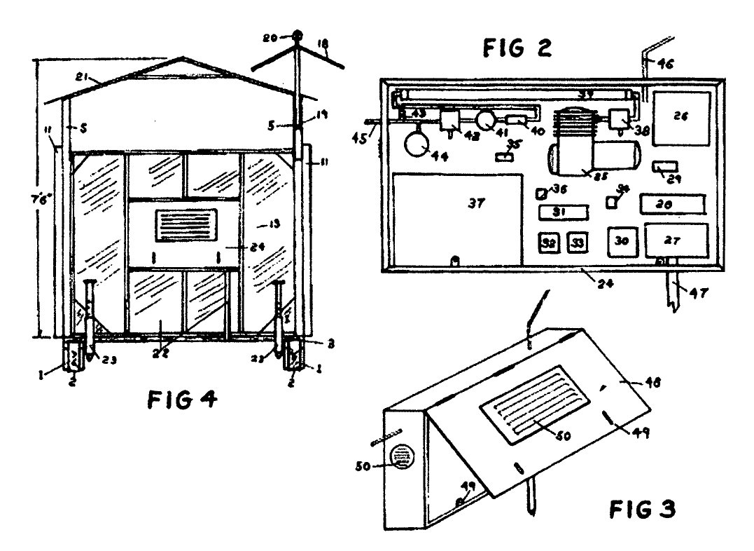

2. FIG. 2—the interior of the control box and the placement of the electrical and air system components

3. FIG. 3—the exterior of the control box as well as the access door and ventilators

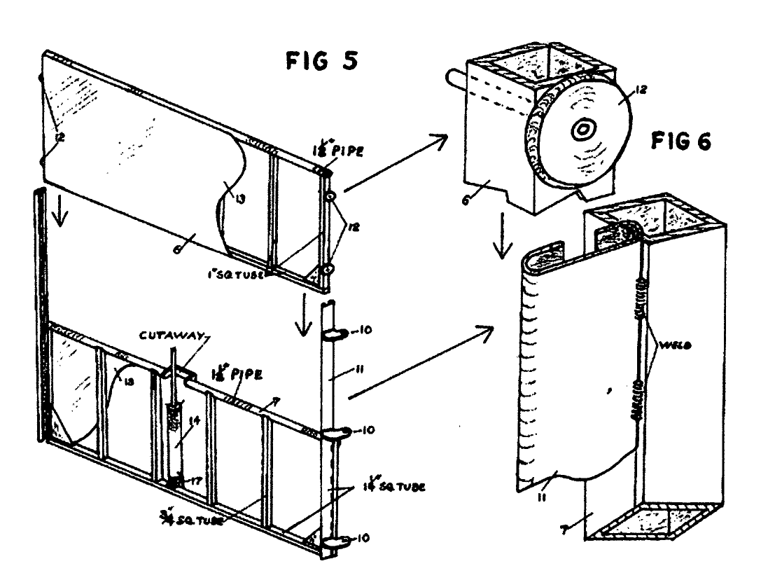

4. FIG. 4—rear view of the unit showing the skids, control box, roof structure, drift spikes, solar panels and mast, feed light and rear wall

5. FIG. 5—shows a detail view of one of the gate assemblies and air-lifting ram

6. FIG. 6—a detail view of the feed gate rollers and roller guide

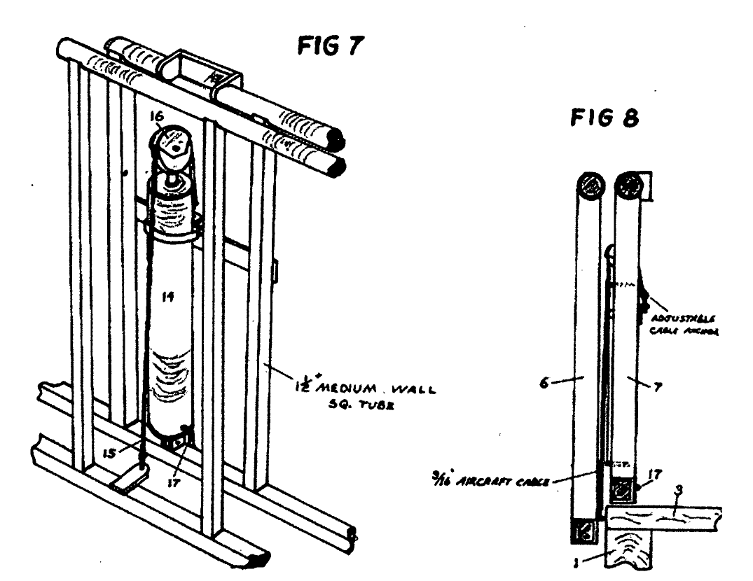

7. FIG. 7—another detail view of one of the gate assemblies, showing the air-lifting mechanism

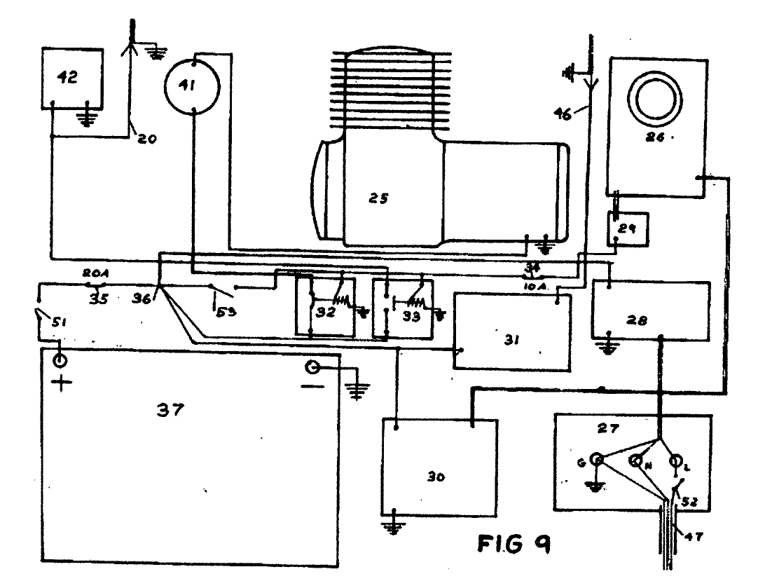

8. FIG. 8—an end view of the fixed inner gate and moveable outer feed gate

9. FIG. 9—wiring schematic, also showing the dual voltage capability

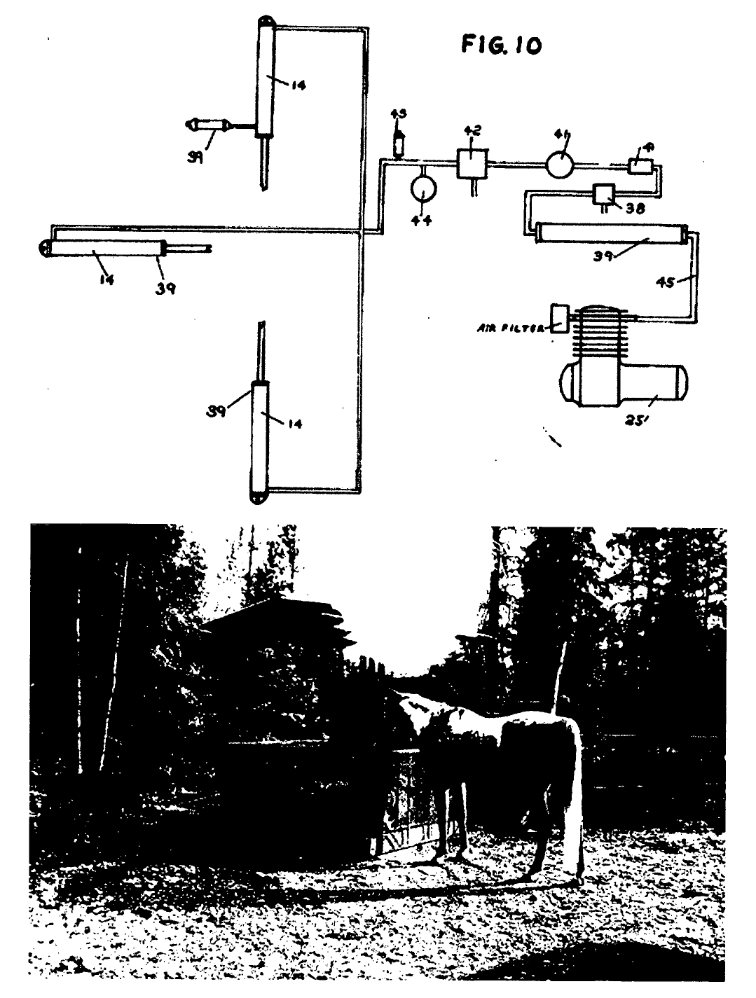

10. FIG. 10—air system schematic

### DETAILED DESCRIPTION OF THE INVENTION

In the overall view, FIG. 1, of the embodiment of the invention, it is shown that the automatic livestock feeder consists of two base runners 1, to each of which is fastened a steel wear strap 2 to protect the runner when towing the unit across rough ground. Steel tow hooks/lifting eyes 4 are fastened to each end of the runners. The base runners are constructed using 6″×8″ pressure treated wood timbers, or fabricated to the aforementioned dimensions using steel. Directly fastened to the top of each runner is a series of pressure treated 2″×8″ boards 3 laid at right angles to said runners to form a floor. Each floor board is fastened to each of the two runners with the appropriate use of wood screws and construction adhesive. The thus formed square base measures (approx.) 7′ on each side. The above embodiment will henceforth be referred to as the base of the invention. Thus, feature 1 of the Summary is fully realized.

Directly fastened to the base of the invention is the solid rear wall 22. At each corner of the base is a post 5, each of which is constructed of 2″ or 3″ steel pipe or square tubing and welded to a flat steel base plate, which is bolted to the base. The said post is gusseted to the base plate for rigidity. The four corner posts support the gate assemblies 6 and 7 using the hinge assemblies and latches 10. The posts also support the rear wall 22 and the roof structure 21 as well as the solar panel mast 19. The roof structure is peaked with a (approx.) 10″ eve and gable overhang and is constructed using steel and wood with tin roofing.

The invention incorporates three gate assemblies, as shown in FIG. 5. Each assembly consists of an outer feed gate 6 and a fixed inner gate 7. The inner gate 7 is rectangular in shape, (approx.) 77″ long and 32″ in height and is constructed using (approx.) 1½″ pipe for the top of the gate and (approx.) 1¼″×⅛″ wall square tube for the side and bottom frame members. Equally spaced across the width of the gate are four vertical frame members of ¾″ square tube. All joints on the inner gates and the feed gates are welded. Attached to each side frame is a roller guide 11, within which the feed gate rollers 12 move up and down in. Welded to the guides 11 are the hinge members 10 of which there are three on one end, and a gate latch 10 on the other end, of each gate. These hinge and latch members fasten to matching members 10 on each corner post 5, as shown in FIG. 1, and allows the gate assemblies to be unlatched and swung open for loading and cleaning. Opening the front gate assembly FIG. 1, 8, 9 is the preferred method of loading feed into the unit.

Each inner gate 7 incorporates an air operated lift-ram 14 to raise and lower the feed gate 6. The air-lift ram is bolted to the bottom frame member of the inner gate and can extend upward through the top of the gate through the cutaway, as shown in FIG. 5. An air-line 17 connected to each ram is fastened to the bottom frame member and connects to the air control system at the rear of the feed unit. Each inner gate 7 is sheathed on the inner side with metal steel mesh or sheet metal 13.

As shown in FIG. 5, each gate assembly utilizes an outer moveable feed gate 6. This gate is rectangular in shape and is approximately 73″ in length and 38″ in height and is constructed of (approx.) 1½″ pipe on its top frame and 1″ square tube for the side and bottom frame members. Shop/garage door type roller units are attached to each door using holes drilled in the side frame members, as shown in FIG. 6.

There are two rollers on each end of the feed gate thus allowing the feed gate to slide up or down in the guides 11 of the inner door 7, as shown in FIG. 6. Each feed gate is sheathed on the outside with steel mesh or sheet metal 13.

FIG. 7 shows that the feed door 6 is raised and lowered using an air operated lift-ram 14. At the top of the air ram rod is mounted a cable pulley 16 that utilizes a cover to hold the 3/16″ aircraft cable 15 in place on the pulley. One end of the cable is attached to the inner gate 7 and the other end is attached to the bottom of the feed gate 6. The operating stroke of the ram is approximately 19½″. Utilizing the pulley arrangement, as shown in FIG. 7, this stroke is now increased to an operating length of approximately 39″. Thus, when the ram rod is extended, the feed gate is lifted up to give a total gate height of (approx.) 70″ from the floor of the base FIG. 1, 1, 2, 3.

FIG. 8 shows that the aircraft cable 15 is anchored to the inner gate with an adjustable eyebolt in order to allow the height of the feed gate 6 to be adjusted in its lowered position, which also allows its raised height to be adjusted. Thus, feature 8 of the Summary is fully realized.

FIG. 4 presents a view of the rear of the invention, showing the base of the invention 1, 2, 3, the ground anchors 23, the control box 24, corner posts 5, and the feed gate roller guide 11.

FIG. 4 also shows the roof structure 21 that is constructed of appropriate sizes of steel square tube, 1″×3″ lathing and metal shed roofing and is fastened to each corner post 5. This feature ensures that the feed remains dry. Thus, feature 10 of the Summary is fully realized.

The solar panel arrangement is also shown in FIG. 4. The solar panel mast 19 rests in a mounting socket 19 and can be rotated to maximize sunlight exposure to the panels 18. The solar panels are of sufficient wattage output as to properly keep the 12 VDC battery 37 charged up. A feed light 20 is located on the top of the mast 19, which illuminates when the feed gates are down for feeding.

FIG. 2 shows a block layout of the location of the various electrical and air system components in the control box 24.

FIG. 3 shows the approximate shape of the control box 24. It will be noted the use of ventilators 50 to help stabilize control box ambient temperatures and the door latches 49 that are of the internal latching type to prevent animals from opening the door 48. The control box 24 is constructed of metal or re-enforced wood and securely anchored to the feed unit rear wall 22.

FIGS. 9 and 10 show schematics of the electrical and air systems. These systems operate in conjunction with each other to cause the feed gates, FIG. 1, 6, to automatically open and close on a programmed time schedule.

FIG. 9 shows the electrical schematic of the control system including the dual voltage capability, whereas 110 VAC 47 enters the junction box 27 through a protective conduit. A master switch 52 is utilized to control the 110 VAC external power. From the junction box 27, 110 VAC is connected in parallel with the 110 VAC output of the power inverter 30, and also to the programmable timer 26 which is capable of multiple on/off settings during a twenty-four hour period. The timer 26 110 VAC output is then routed to a 110 VAC/12 VDC dual voltage relay 29 which activates to allow 12 VDC from the battery 37 to operate the compressor 25, air system dump valve 42, through relays 32, 33, and the feed light 20.

When the unit is operating in the 12 VDC mode, the electrical power is supplied by the battery 37 only. This battery is kept charged by the solar panels FIG. 1, 18 via wiring circuit 46 and optional solar panel voltage controller 31. A master switch 51 is utilized to control the battery 37 power to the system The 110 VAC required by the timer 26 is supplied by the 12 VDC to 110 VAC inverter 30, and henceforth the operation is as described above. The 12 VDC sections of the control system are protected from overload by fuses and/or circuit breakers 34, 35. Thus, feature 9 of the Summary is fully realized.

The 12 VDC NC air system dump valve 42 is controlled by NO relay 33. When the twenty-four hour timer 26 reaches one of it's preset program settings, 110 VAC is sent to the 110 VAC/12 VDC relay 29 and the resulting 12 VDC is supplied to NC relay 32 and NO relay 33 which activate to shut off the compressor 25, and to open the NC dump valve 42 which causes the air pressure in the system to drop to 0 psi, thus allowing the feed gates FIG. 1, 6 to drop down to the feeding position. At the end of the programmed time for feeding, the timer 26 causes the 12 VDC input to the relays 32 and 33 to cease, thus allowing the relays to activate the compressor 25, and to close off the dump valve 42. The air system will now build up to operating pressure, causing the feed gates FIG. 1, 6 to move upward to the closed position, thus shutting off animal access to the feed. A manual dump valve switch 53 is incorporated between 12 VDC junction terminal 36 and compressor relay 32 and dump valve relay 33 in order to provide manual up and down control of the feed gates FIG. 1, 6, regardless of timer 26 operation. When the air system reaches approximately 95 psi, the NC pressure switch 41 activates to shut off the compressor 25, thus completing the feed cycle and thus, insuring that feature 3 of the Summary is fully realized.

FIG. 10 shows the overall layout of the air system that is utilized to raise and lower the feed gates FIG. 1, 6. A 12 VDC air compressor 25, complete with an inlet filter/air dryer, supplies clean compressed air through a flex hose to an air dryer unit 39, which removes all moisture to prevent cold weather freezing problems. A one-way check valve 40 is utilized to maintain system air pressure, while an optional bleed-off valve 38 is inserted between the check valve and the compressor 26 to slowly bleed off the air pressure to ease the compressor start up load. An adjustable NC pressure switch 41 senses air system pressure and shuts off the compressor at approximately 95 psi and turns it on at approximately 75 psi. The 12 VDC air dump valve 42 is activated by the timer 26 at preset feeding times to dump all the air from the system to allow the feed gates FIG. 1, 6 to come down by gravity. An air pressure gauge 44 shows system pressure at all times. An adjustable air pressure relief valve 43 ensures that system pressure does not exceed 105 psi. Air-lift rams 14 are utilized, one in each gate assembly FIG. 1, 6, 7, to operate the feed gates. Each ram is a single acting unit with the upper chamber vented to atmosphere through a small vented air dryer 39, and the lower chamber connected by an airline to the control box FIG. 1, 24. Inherent in the design of any air system, tiny leaks will occur allowing a pressure loss, thus causing the pressure switch 41 to periodically activate the compressor 25 in order to pressurize the system back up to the preset cut-off pressure of 95 psi. In the event of compressor or control system malfunction or failure, the aforementioned tiny leakage insures that the air system pressure will eventually fall to the point where the feed gates will not be held by air pressure in the closed position and will slowly drop down by gravity to the feeding position. Thus, feature 5 of the Summary is fully realized.

Described above is a description of each of the components in the feeder control system, whereas their actual function in relation to the typical operation of this automatic livestock feeder is as follows:

Unless otherwise stated, Drawing FIG. 9 is to be referred to.

Starting with a time just prior to the beginning of a programmed feeding time, as will be initiated by the timer 26 eg. 6:00 am start; 8:00 am finish . . . the status of the automatic livestock feeder is now: FEED GATES CLOSED
1. system air pressure is between 75 psi and 95 psi
2. air pressure switch 41 is open and compressor is off
3. dump valve 42 is closed
4. feed gates FIG. 1, 6 are fully up (closed)
5. timer 26 is running

When the timer detects 6:00 am, it sends 110 VAC from it's output to the 110 VAC/12 VDC relay 29, which in turn sends 12 VDC to NC relay 32, which shuts off power to the compressor 25 via the NC pressure switch 41. 12 VDC also goes to the NO relay 33 which causes the NC dump valve 42 to open, thus allowing all the air in the system to exhaust and pressure to drop to 0 psi. 12 VDC is also sent from NO relay 33 to the feed light FIG. 1, 20 on the roof. When the system air pressure falls below (approx.) 40 psi the feed gates FIG. 1, 6 slowly start to drop by gravity to their fully open or feeding position.

The status of the automatic livestock feeder is now: FEED GATES OPEN
1. system air pressure is at 0 psi
2. air pressure switch 41 is closed and compressor is off
3. dump valve 42 is open and system air is exhausted
4. feed gates FIG. 1, 6 are fully down (open)
5. feed light FIG. 1, 20 is on
6. timer 26 is running

At the end of the programmed feed time, the timer 26 will detect 8:00 am and cause the 110 VAC from it's output to 110 VAC/12 VDC relay 29 to cease, which allows NC relay 32 to close, thus sending 12 VDC to the pressure switch 41, (which is now closed and will only open when air pressure reaches 95 psi) and through it to the compressor 25. 12 VDC is also shut off to the NO relay 33 which allows the NC dump valve 42 to close off.

The status of the automatic livestock feeder is now: FEED GATES CLOSING
1. compressor 25 is operating and dump valve 42 is closed
2. system air pressure is building up to 95 psi, at which time the pressure switch 41 will open and cause the compressor 25 to shut off
3. at (approx.) 40 psi the feed gates FIG. 1, 6 will slowly start to be lifted up by the air-lift rams FIG. 1, 14 to their closed position
4. feed light FIG. 1, 20 is off
5. timer 26 is running.

The above-described feed cycle will repeat at every timer initiated feeding time.

Thus, it has been shown that this feeder unit is fully automatic in operation and programmable as to it's times of operation.

It will be further noted that:
1. The feed gates FIG. 1, 6 can be adjusted as to the speed at which they come down for feeding or go up to close.
2. The feed gates can be caused to operate using the manual dump switch 53, regardless of timer settings.
3. The air system pressure switch 41 (compressor cut in and cut out pressures) is adjustable.
4. The air system incorporates a safety relief valve FIG. 10, 43 which is set at (approx.) 10 psi above system operating pressure.
5. The control system can be operated on 110 VAC or 12 VDC (battery 37 to be charged by a battery charger 28, or via solar panels FIG. 1, 18).
6. The timer 26 is capable of multiple programmable on-off times in a 24-hour period.
7. Cold weather freeze up of the air system is prevented by the desiccant filled air dryers FIG. 10, 39.

Although this invention has been described in connection with a preferred embodiment, it should be understood that various modifications, additions and alterations may be made to the invention by one skilled in the art without departing from the spirit and scope of the invention as defined in the appended claims.

The embodiments of the invention in which an exclusive property or privilege is claimed are defined as follows:

1. An automatic livestock feeder to facilitate the daily feeding of baled hay, loose hay or silage to horses or cattle in a controlled manner comprising a said square base of the invention, consisting of two skids or runners and a floor fastened to the top of said skids or runners, upon which four vertical posts are installed, one on each corner. Said vertical posts support the three moveable gate assemblies, each said gate assembly being defined as an fixed inner gate and an moveable outer feed gate that is able to move vertically utilizing guided rollers, an air-lift ram and a cable arrangement. In addition, said gate assemblies are sheathed with expanded metal mesh or sheet metal and are hinged to said vertical posts on one end, in order for them to swing open; and latched to said vertical posts on the other. Said vertical posts also support the roof structure. Said roof structure being defined as the rafters, gables, purloins, tin roofing, solar panel mast and panels and feed light. In addition, said vertical posts support the rear wall. Said rear wall extends from one vertical post to the other across the rear of the unit and also supports the control box. Said control box is defined as a rectangular enclosure which houses the battery, timer, inverter, battery charger, solar panel voltage controller, relays, 110 VAC/12 VDC relay, fuses, master switches, compressor, air dryer, dump valve and manual switch, pressure switch, check valve, pressure gauge, bleed-off valve, and relief valve, as per Drawings FIG. 2, 3, 9, and 10.

2. The automatic livestock feeder recited in claim 1, whereas said baled hay, loose hay or silage is contained in an enclosure consisting of said base of the invention, roof structure, gate assemblies and rear wall.

3. The automatic livestock feeder recited in claim 1, whereas said floor is laid upon said runners or skids, which are constructed of said pressure treated timbers fitted with metal bottoms or fabricated using steel, which has been recited as the base of the invention.

4. The automatic livestock feeder recited in claim 1, whereas the said roof structure is fabricated from wood and steel and incorporates a peak in the middle and an overhang on both eves as well as both gable ends.

5. The automatic livestock feeder recited in claim 1, whereas a said gate assembly contains a said fixed inner gate which consists of a steel frame, steel mesh or sheet metal sheathing, side hinges, side latch, air-lift ram and cable arrangement, roller guides and air dryer.

6. The automatic livestock feeder recited in claim 1, whereas a said gate assembly contains a said moveable outer feed gate which consists of a steel frame, steel mesh or sheet metal sheathing and guided rollers.

7. The automatic livestock feeder recited in claim 1, whereas the said rear wall consists of a steel frame, steel mesh sheathing, and is secured to the two rear said vertical posts using bolts and nuts and acts as a solid support for the rear vertical posts, in addition to providing support for said control box.

8. The automatic livestock feeder recited in claim 1, whereas the said roof structure acts as a solid support for said four vertical posts.

9. The automatic livestock feeder recited in claim 1, whereas the said vertical posts are further strengthened against lateral movement by the utilization of diagonal corner braces between the four vertical posts and said roof structure.

10. The automatic livestock feeder recited in claim 1, whereas the said air-lift ram arrangement recited in claim 5 consists of an air-lift ram with a cable pulley assembly and attached guide cover for the cable arrangement. Said air-lift ram assembly is bolted to the said fixed inner gate and the cable is anchored on one end to the fixed inner gate near the air-lift ram upper mount and on the other end to the bottom of the said moveable outer feed gate in such a way as to allow the air-lift ram rod to fully extend, which in turn, utilizing the said cable arrangement, Drawing FIG. 7, causes the moveable outer feed gate to raise upward to a height of approximately twice the stroke length of the air-lift ram.

11. The automatic livestock feeder recited in claim 1, whereas each of the three said fixed inner gates recited in claim 5 incorporates garage/shop door roller type guides, one on each end, in an advantageous arrangement, so as to facilitate the vertical movement of the said moveable outer feed gate recited in claim 6. Said moveable outer feed gate incorporates said guide rollers, two on each end, that roll within and are contained by the roller guides. In addition, there are roller travel limit stoppers at either end of each said roller guide to prevent said moveable outer feed gates from exceeding their design travel.

12. The automatic livestock feeder recited in claim 1, whereas the three said fixed inner gates recited in claim 5 contain said air dryers, each of which is comprised of a (approx.) 6″ section of ¾″ inch galvanized pipe threaded on each end with a ¾″ inch to ¼″ inch bell reducer screwed on each end and whereas said pipe contains a quantity of desiccant moisture absorbing material, the purpose of which is to absorb any moisture from the air being drawn into the top portion of the air-lift ram during feed gate operation. Said air dryers are attached to the said fixed inner gate on the inside. One end of this air dryer is connected by plastic air line and fittings to the top port of the air-lift ram and utilizes a filter on its other end as well as a foam filter inside each end of said pipe to prevent desiccant material from entering the top chamber of the air-lift ram.

13. The automatic livestock feeder recited in claim 1, whereas the three said gate assemblies utilize three said hinges on one end and one said latch on the other end, and are supported by said vertical posts.

14. The automatic livestock feeder recited in claim 1, whereas each of the two said skids or runners incorporates a steel tow hook/lifting eye, one fastened on each end of the runner.

15. The automatic livestock feeder recited in claim 1, whereas the said floor of said base of the invention consists of treated boards (e.g. 2″×8″) or sheet metal which is fastened by screws or welding to the base runners.

16. The automatic livestock feeder recited in claim 1, whereas the said control box is fabricated using plywood (e.g. ½″) with steel reinforced edges or from sheet metal and utilizes three upper hinges, an internal latch arrangement and three ventilators.

17. The automatic livestock feeder recited in claim 1, whereas the said control box contains all the said components recited in claim 1, wherein, the utilization of said components, in compliance with the wiring schematic of Drawing FIG. 9 and air system schematic of Drawing FIG. 10 and the component placement layout of Drawing FIG. 2, and in conjunction with the spirit and scope of the actual operation of this automatic livestock feeder which has been described in the Description of the Invention, together constitute an integral part of the embodiment of this invention.

18. The automatic livestock feeder recited in claim 1, whereas said air dryer consists of a (approx.) 16″ section of ¾″ galvanized pipe, threaded on each end, whereas a ¾″ to ¼″ bell reducer is screwed onto each end of said pipe, which is filled with a desiccant moisture absorbing material to remove moisture from the compressed air being delivered from said compressor to the rest of the air system. Also, contained within each end of said pipe is a foam filter to prevent desiccant material from entering the air system. This air dryer is attached to the inside of said control box and connected to the other components using plastic air line and fittings, as shown by air system schematic Drawing FIG. 10, and thus constitutes an integral part of the utilization of said components as recited in claim 17.

19. The automatic livestock feeder recited in claim 1, whereas the three said gate assemblies, comprised of said fixed inner gates and said moveable outer feed gates and all attached said components as recited in clams 1, 5, 6, and in conjunction with the spirit and scope of the actual operation of this automatic livestock feeder, as described on page 4 of the Description of the Invention, constitutes an integral part of the embodiment of this invention.

20. The automatic livestock feeder recited in claim 1, whereas said solar panels and mast comprise an integral part of the utilization of said components as recited in claim 17, and thus constitutes an integral part of the embodiment of this invention.
